(19) United States
(12) Patent Application Publication
(10) Pub. No.: US 2015/0310432 A1
(43) Pub. Date: Oct. 29, 2015

(54) SECURE ELEMENT ARCHITECTURAL SERVICES

(71) Applicant: GOOGLE INC., Mountain View, CA (US)

(72) Inventors: Nilesh B. Pusuluri, Flower Mound, TX (US); Philip A. Robertson, Wylie, TX (US); Balamourougan Ranganathan, Cumming, GA (US); Yale P. Vinson, Flower Mound, TX (US); Xiaodong Guo, Leiden (NL); Bart S. van Hoek, Dallas, TX (US); James C. High, JR., Crandall, TX (US)

(21) Appl. No.: 14/698,813

(22) Filed: Apr. 28, 2015

Related U.S. Application Data
(60) Provisional application No. 61/985,155, filed on Apr. 28, 2014.
(60) Provisional application No. 62/005,327, filed on May 30, 2014.
(60) Provisional application No. 62/005,338, filed on May 30, 2014.
(60) Provisional application No. 62/005,348, filed on May 30, 2014.
(60) Provisional application No. 62/026,159, filed on Jul. 18, 2014.

(51) Int. Cl. G06Q 20/38

(52) U.S. Cl. CPC G06Q 20/3829; G06Q 40/02

(57) ABSTRACT

A method for securely adding financial accounts maintained by an issuer without an issuer-specific TSM to a secure element using a service system that creates a secure TSM add-on module for the issuer within the service system TSM, and a sub-domain that is specific to the issuer within the secure element. The issuer designates instructions and commands as insecure information and sensitive financial information as secure information, and communicates each type of information via a designated interface that is designed to correspond to the required security of the type of information. The issuer transmits insecure instructions to the service system and in turn a digital wallet application to create a new account record in the application. The issuer encrypts the secure financial information and transmits it to the issuer domain of the secure element through the account services system TSM over a dedicated interface.

### RELATED APPLICATION

This patent application claims priority under 35 U.S.C. § 119 to U.S. Patent Application No. 61/985,155, filed Apr. 28, 2014 and entitled “Systems, Methods, and Computer Program Products for Providing Issuer Integration,” U.S. Patent Application No. 62/005,327, filed May 30, 2014 and entitled “Systems, Methods, and Computer Program Products for Providing a Secure Element Architecture,” U.S. Patent Application No. 62/005,338, filed May 30, 2014 and entitled “Systems, Methods, and Computer Program Products for Providing an Interface Proxy,” U.S. Patent Application No. 62/005,348, filed May 30, 2014 and entitled “Systems, Methods, and Computer Program Products for Managing Instrument Personalization,” and U.S. Patent Application No. 62/026,159, filed Jul. 18, 2014 and entitled “Systems, Methods, and Computer Program Products for Providing a Process Aggregator.” The entire contents of the above-identified applications are hereby fully incorporated herein by reference.

### TECHNICAL FIELD

The present disclosure relates to allowing issuer systems to add financial account information to a secure element without an issuer-specific trusted services manager (“TSM”), thereby allowing issuer systems that lack resources and/or expertise to acquire a TSM to participate in mobile communication financial services.

### BACKGROUND

Current near field communication (“NFC”) systems rely on a hardware component commonly referred to as a “secure element” or “secure memory” installed on communication devices to provide a secure operating environment for financial transactions, transit ticketing, identification and authentication, physical security access, and other functions. A secure element generally includes its own operating environment with a tamper-proof microprocessor, memory, and operating system.

A trusted service manager (“TSM”), or other form of secure service provider, can, among other things, install, provision, and personalize applications and data in the secure element. The secure element has one or more access keys. A corresponding key is shared by the TSM so that the TSM can establish a cryptographically secure channel to the secure element for installation, provisioning, and personalization of the secure element while the device having the secure element is in the possession of an end user. In this way, the secure element can remain secure even if the host CPU in the device has been compromised.

The secure element can be provisioned to provide a sub-domain that is specific to an issuer system that maintains a financial account for the user. The sub-domain is specific to the issuer system and allows the user to securely store the financial account information for use in a digital wallet payment transaction. One deficiency with the current secure element systems is that the issuer system is required to acquire and maintain an issuer-specific TSM to facilitate the addition of the user's financial account information to the secure element sub-domain. Issuers without the programming capabilities and sophistication to acquire a TSM, for example credit unions and small banks, are accordingly not capable of allowing a user to add their financial account information for use in digital wallet payment transactions.

### SUMMARY

In certain example aspects described herein, computer-implemented methods for securely adding financial accounts maintained by issuer systems without an issuer-specific TSM to secure element interfaces comprise a secure element that is controlled by or in communication with an account services system, which is separate and distinct from the issuer system. The account services system comprises a TSM that securely manages the keys required to communicate and instruct the secure element. The account services system TSM invokes a secure TSM add-on module for an issuer system that is partitioned within the account services system TSM. The account services system TSM instructs the secure element to partition a sub-domain that is specific to the issuer system.

The issuer system designates instructions and commands as insecure information and sensitive financial information as secure information. Each type of information is communicated via a designated interface that is designed to correspond to the required security of the type of information. The issuer system transmits insecure instructions and commands over a dedicated interface using a series of API calls to the account services system and in turn a digital wallet application. A new financial account record in the digital wallet application is created that comprises an account identifier, but not sensitive financial account information. The issuer system encrypts the secure financial account information and transmits it to the issuer domain of the secure element through the account services system over a dedicated interface using a series of API calls to the issuer TSM module. The issuer TSM module passes the secure information to the account services system TSM, which modifies the secure transmission so that it is partly understandable by the secure element. In an example embodiment, the secure element is capable of partial decryption of the information so that it can pass the information to the correct issuer domain where it is stored.

In certain other example aspects described herein, systems and computer program products to authenticate users are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a secure element architectural system, in accordance with certain example embodiments.

FIG. 2 is a block flow diagram depicting a method for securely adding a financial account maintained by an issuer system without an issuer-specific TSM to a user computing device secure element, in accordance with certain example embodiments.

FIG. 3 is a block flow diagram depicting a method for instructing an issuer system to add a new financial account to the user computing device secure element, in accordance with certain example embodiments.

FIG. 4 is a block flow diagram depicting a method for notifying the account services system of the pending financial account, in accordance with certain example embodiments.

FIG. 5 is a block flow diagram depicting a method for creating an issuer domain on the user computing device secure element, in accordance with certain example embodiments.

FIG. 6 is a block flow diagram depicting a method for creating a financial account record using insecure financial account information, in accordance with certain example embodiments.

FIG. 7 is a block flow diagram depicting a method for transmitting secure financial account information to the user computing device secure element, in accordance with certain example embodiments.

FIG. 8 is a block diagram depicting a computing machine and module, in accordance with certain example embodiments.

### DETAILED DESCRIPTION OF THE EXAMPLE EMBODIMENTS

### Overview

The example embodiments described herein provide methods and systems that enable an issuer system without an issuer-specific TSM to allow users to securely store their financial account information for use in a digital wallet payment transaction. In an example embodiment, the user accesses a digital wallet application on a user computing device and instructs the issuer system to add new financial account information to the user's digital wallet account. For example, the user wishes to add a Credit Union XYZ VISA card to the user's digital wallet account so that the user can complete digital wallet payment transactions using the saved VISA card information. In this example, the user's VISA card is maintained by Credit Union XYZ and Credit Union XYZ is accordingly the issuer system that corresponds to the VISA account. The user accesses the digital wallet application on the user computing device and requests the addition of the Credit Union XYZ card. In an example embodiment, the digital wallet application launches an issuer system web page that allows the user to enter or select the correct financial account.

In an example embodiment, the user computing device comprises a secure element or secure memory that is controlled by or in communication with an account services system. In an example embodiment, the account services system is separate and distinct from the issuer system. In this embodiment, the account services system is capable of instructing the secure element to add new financial account information, provision a sub-domain, modify financial account information, and perform other financial account related activities. In an example embodiment, the account services system is also capable of communicating with the digital wallet application on the user computing device. In this embodiment, the digital wallet application comprises account identifiers and commands that correspond to securely stored financial account information within the secure element. In an example embodiment, the issuer system communicates the user's request to add new financial account information to the account services system. In an example embodiment, the request is transmitted through a designated interface as a series of API calls. In another example embodiment, the request is transmitted in a batch process through a network interface. In an example embodiment, the issuer system designates certain financial information as sensitive and only transfers that information through an interface dedicated and designed to handle sensitive and highly secure information. In another example embodiment, the issuer system designates other information as less sensitive and accordingly is capable of transmitting the information through less secure interfaces.

In an example embodiment, the account services system comprises a TSM that comprises the keys required to communicate and instruct the secure element. In another example embodiment, the issuer system does not comprise a separate TSM. In this embodiment, the account services system TSM creates a secure TSM add-on module for the issuer system. In an example embodiment, the issuer TSM module is partitioned within the account services system TSM. The account services system TSM also instructs the secure element to partition a sub-domain that is specific to the issuer system. The financial account information maintained by the issuer system will be written in the issuer domain of the secure element. In an example embodiment, the issuer TSM module securely manages the keys to communicate with, modify, and add new financial account information within the issuer domain of the secure element.

The issuer system transmits instructions and commands to the digital wallet application through the account services system to create a new financial account record. In an example embodiment, the new financial account record in the digital wallet application comprises an account identifier, but not sensitive financial account information. In an example embodiment, the account identifier becomes connected to the corresponding sensitive financial account information stored in the issuer domain of the secure element. In an example embodiment, the issuer system designates the commands and instructions as insecure information and passes the information to the account services system through a dedicated interface using a series of API calls. In another example embodiment, the issuer system provides a batch file to the account services system. In this embodiment, the account services system pulls the insecure information directly from the issuer system and communicates it to the digital wallet application.

The issuer system encrypts the secure financial account information and transmits it to the issuer domain of the secure element through the account services system. In an example embodiment, the secure information is passed over a dedicated interface using a series of API calls to the issuer TSM module. In an example embodiment, the issuer TSM module encrypts the secure information so that it is only understandable by the issuer domain of the secure element. The issuer TSM module passes the secure information to the account services system TSM, which modifies the secure transmission so that it is partly understandable by the secure element. In an example embodiment, the secure element is capable of partial decryption of the information so that it can pass the information to the correct issuer domain where it is stored. In an example embodiment, the secure financial account information is written to the issuer domain of the secure element.

By using and relying on the methods and systems described herein, the secure element architectural system provides a proxy interface that allows simplified access to secure element services for issuers and service providers that lack the resources and/or expertise to acquire and maintain the TSM resources necessary to interface with secure elements. The secure element architectural service provides these smaller and less sophisticated issuers with proxy TSM services. As such, the service provides an API to allow a command issued by an issuer system (for example, to add a new financial account number to a user device) to be securely received and executed by the proxy TSM to permit access to the secure element by the issuer through the proxy TSM. The service provisions the secure and insecure financial account information such that the secure information is passed through the proxy TSM directly to the secure element and the insecure information is communicated to the application(s) on the user computing device. The provisioning of the secure and insecure information allows for more direct targeting and better communication of only that information that is required by the corresponding destination. The provisioning of secure and insecure information also permits insecure information to pass freely on a designated interface without the need for strict security standards. Additionally, the real time or near-real time receipt and re-transmission of the secure information allows the service provider to pass on the secure information without storing or saving it. Thus, allowing the service provider to operate without compliance with strict security standards.

Various example embodiments will be explained in more detail in the following description, read in conjunction with the figures illustrating the program flow.

### Example System Architectures

Turning now to the drawings, in which like numerals indicate like (but not necessarily identical) elements throughout the figures, example embodiments are described in detail.

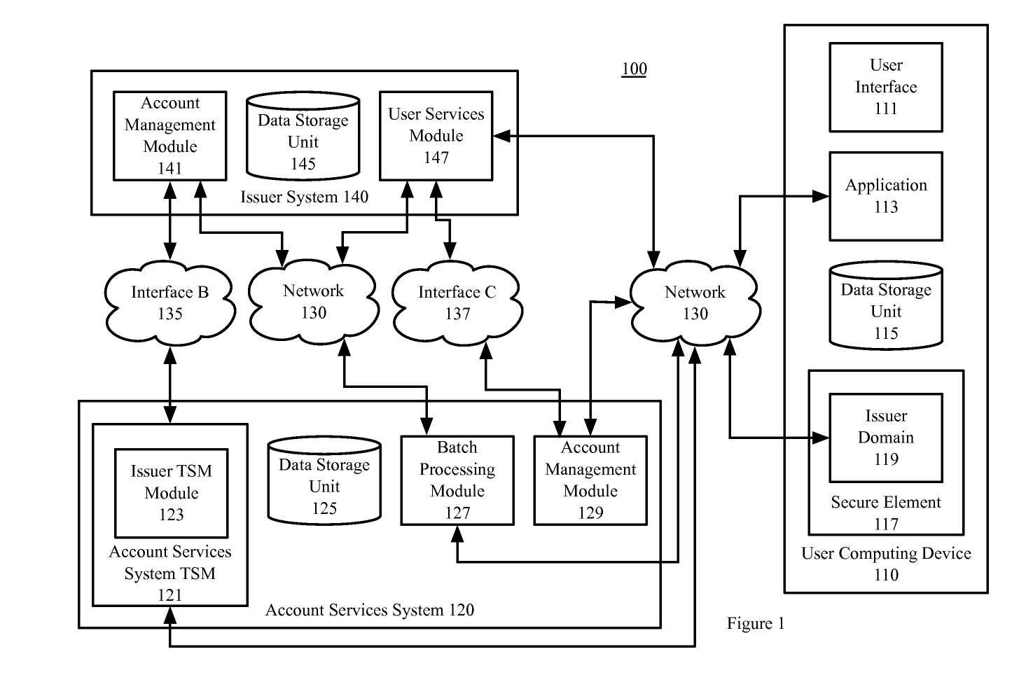

FIG. 1 is a block diagram depicting a secure element architectural system, in accordance with certain example embodiments. As depicted in FIG. 1, the exemplary operating environment 100 comprises a user computing device 110, an account services computing system 120, and an issuer computing system 140, that are configured to communicate with one another via one or more networks 130 and interfaces 135 and 137. In another example embodiment, two or more of these systems (including systems 110, 120, and 130) are integrated into the same system. In some embodiments, a user associated with a device must install an application and/or make a feature selection to obtain the benefits of the techniques described herein.

Each network 130 includes a wired or wireless telecommunication means by which network systems (including systems 110, 120, and 130) can communicate and exchange data. For example, each network 130 can be implemented as, or may be a part of, a storage area network (SAN), personal area network (PAN), a metropolitan area network (MAN), a local area network (LAN), a wide area network (WAN), a wireless local area network (WLAN), a virtual private network (VPN), an intranet, an Internet, a mobile telephone network, a card network, Bluetooth, Bluetooth Low Energy (BLE), near field communication network (NFC), any form of standardized radio frequency, infrared, sound (for example, audible sounds, melodies, and ultrasound), other short range communication channel, or any combination thereof, or any other appropriate architecture or system that facilitates the communication of signals, data, and/or messages (generally referred to as data). Throughout this specification, it should be understood that the terms “data” and “information” are used interchangeably herein to refer to text, images, audio, video, or any other form of information that can exist in a computer-based environment.

In an example embodiment, each network computing system (including systems 110, 120, and 130) includes a device having a communication module capable of transmitting and receiving data over the network 130. For example, each network system (including systems 110, 120, and 130) may comprise a server, personal computer, mobile device (for example, notebook computer, tablet computer, netbook computer, personal digital assistant (PDA), video game device, GPS locator device, cellular telephone, smartphone, or other mobile device), a television with one or more processors embedded therein and/or coupled thereto, or other appropriate technology that includes or is coupled to a web browser or other application for communicating via the network 130. In the example embodiment depicted in FIG. 1, the network systems (including systems 110, 120, and 130) are operated by a user, account services manager, and an issuer, respectively.

Modules and/or components of the systems (including systems 120 and 140) can communicate and exchange data via a pre-defined interface (including interface B 135 and interface C 137). In an example embodiment, each interface (including 135 and 137) comprises a series of application program interface (“API”) calls between the modules and/or systems. The API defines the routines/protocol and specifies how the modules should interact, thereby defining the relations between modules. In an example embodiment, the systems (including systems 120 and 140) create pre-defined lists of communications and/or commands that are permitted over each interface (including interface B 135 and interface C 137).

In an example embodiment, the issuer system 140 maintains one or more financial accounts for the user, for example a bank, credit union, or other financial institution. In an example embodiment, the issuer system 140 does not maintain an issuer-specific TSM and is not capable of directly provisioning a secure element 117 or adding financial account information to the secure element 117.

In an example embodiment, the user computing device 110 may be a personal computer, mobile device (for example, notebook, computer, tablet computer, netbook computer, personal digital assistant (PDA), video game device, GPS locator device, cellular telephone, Smartphone or other mobile device), television, wearable computing devices (for example, watches, rings, or glasses), or other appropriate technology that includes or is coupled to a web server, or other suitable application for interacting with web page files and/or completing payment transactions. The user can use the user computing device 110 to request the addition of a new financial account to the user's digital wallet application 113 and/or secure element 117 via a user interface 113 and an application 113.

The application 113 is a program, function, routine, applet or similar entity that exists on and performs its operations on the user computing device 110. For example, the application 113 may be one or more of a shopping application, merchant application, an Internet browser, a digital wallet application, a loyalty card application, another value-added application, a user interface 111 application, or other suitable application operating on the user computing device 110. In some embodiments, the user must install an application 113 and/or make a feature selection on the user computing device 110 to obtain the benefits of the techniques described herein.

An example user computing device 110 comprises a secure element 117 or secure memory, which can exist within a removable smart chip or a secure digital (SD) card, which can be embedded within a fixed chip on the device 110, or be realized as a secure compartment of a security-enhanced operating system. In certain example embodiments, Subscriber Identity Module (SIM) cards may be capable of hosting a secure element 117, for example, an NFC SIM Card. The secure element 117 allows a software application resident on the device 120 and accessible by the device user to interact securely with certain functions within the secure element 117, while protecting information stored within the secure element 117. The secure element 117 comprises applications running thereon that perform the functionality described herein. In an example embodiment, the secure element 117 comprises components typical of a smart card, such as crypto processors and random generators. In an example embodiment, the secure element 117 comprises a Smart MX type NFC controller in a highly secure system on a chip controlled by a smart card operating system, such as a JavaCard Open Platform (JCOP) operating system. In another example embodiment, the secure element 117 is configured to include a non-EMV type contactless smart card, as an optional implementation. The secure element 117 communicates with the application 113 in the user computing device 110. In an example embodiment, the secure element 117 is capable of storing encrypted user information and only allowing trusted applications to access the stored information. In an example embodiment, a controller (not shown) interacts with a secure key encrypted application 113 for decryption and installation in the secure element 117.

Additionally, the secure element 117 also may comprise secure software applications, such as a digital wallet application, payment applications, secure forms of the applications 113, authentication applications, payment provisioning applications, or other suitable application using the secure functionality of the secure element 117.

In an example embodiment, the data storage unit 115 and application 113 may be implemented in the secure element 117, as described previously, on the user computing device 110. In another example embodiment, the data storage unit 115, may be a separate memory unit resident on the user computing device 110. In an example embodiment, the data storage unit 115 can include any local or remote data storage structure accessible to the user computing device 110 suitable for storing information. In an example embodiment, the data storage unit 115 stores encrypted information, such as HTML5 local storage. An example data storage unit 115 enables storage of insecure user financial information.

An example secure element 117 comprises one or more sub-domains 119 specific to an issuer system 140. In an example embodiment, each issuer domain 119 is provisioned within the secure element 117 to store financial account information maintained by the issuer system 140 and permit use of the stored financial account information in a digital wallet application 113 payment transaction.

An example user computing device 110 communicates with the account services system 120 to provision the issuer domain 119 within the secure element 117 and add the financial account information. In an example embodiment, a TSM 121 of the account services system 120 hosts, installs, and provisions applications and secure financial account information onto the secure element 117 of the user computing device 110. In another example embodiment, the account services system TSM 121 aids in the provisioning of the secure element 117 to create the issuer domain 119. In an example embodiment, an add-on module is created within the account services system TSM 121 that is specific to the issuer system 140. In an example embodiment, the issuer TSM module 123 is autonomous from the account services system TSM 121.

The account services system TSM 121 can receive, store and utilize a key for the secure element 117. By having the keys, the account services system TSM 121 can access the secure element 117 via a secure encrypted communication channel to install, provision, and customize applications within the secure element 117. In an exemplary embodiment, the key allows access and control of the secure element 117 only by the TSM with the current access key. For example, once control of the issuer domain 119 within the secure element 117 is transferred to the issuer TSM module 123, only the issuer TSM module 123 can access and control the issuer domain 119.

An example account services system 120 comprises an account management module 129 that communicates with the user services module 147 of the issuer system 140 via a pre-defined API interface (interface C 137) to exchange insecure and non-sensitive account information and command/control directions. In an example embodiment, the account management module 129 also communicates with the application 113 to exchange insecure and non-sensitive account information and command/control directions to aid in the addition, modification, and/or removal of financial account information.

In an example embodiment, information is exchanged between the issuer system 140 and the account services system 120 in a batch process. In this embodiment, a list of account identifiers is passed from the issuer system 140 to the batch processing module 127 to aid in the addition of new financial account information to the secure element 117. In this embodiment, information is passed via hypertext transfer protocol (“HTTP”), file transfer protocol (“FTP”), or other transfer protocol to the batch processing module 127. The batch processing module 127 then pulls the secure financial information from the issuer system 140 as needed by the account services system TSM 121 and/or issuer TSM module 123 to populate the issuer domain 119 or secure element 117. In an example embodiment, the secure financial information passes through the account services system 120 without being stored.

In another example embodiment, secure financial information is transferred in real time from the account management module 141 of the issuer system 140 to the account services system TSM 121 through a pre-defined API interface (interface B 135). In an example embodiment, the account services system TSM 121 and/or issuer TSM module 123 communicates the secure financial information directly to the issuer domain 119 or secure element 117 without being stored at the account services system 120.

In an example embodiment, the data storage unit 125 and 145 can include any local or remote data storage structure accessible to the systems (including system 120 and 140) suitable for storing information. In an example embodiment, the data storage unit 125 and 145 stores encrypted information, such as HTML5 local storage.

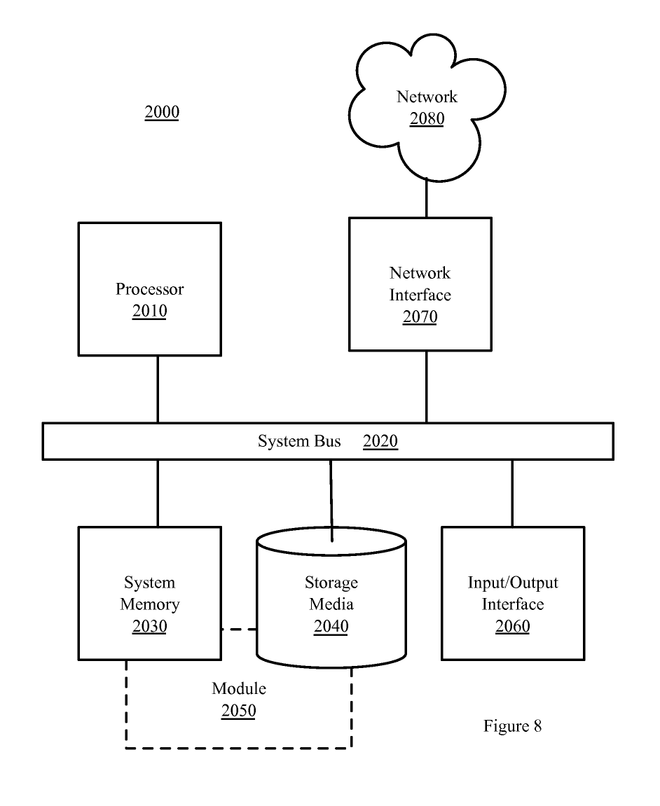

In example embodiments, the network computing devices and any other computing machines associated with the technology presented herein may be any type of computing machine such as, but not limited to, those discussed in more detail with respect to FIG. 8. Furthermore, any modules associated with any of these computing machines, such as modules described herein or any other modules (scripts, web content, software, firmware, or hardware) associated with the technology presented herein may by any of the modules discussed in more detail with respect to FIG. 8. The computing machines discussed herein may communicate with one another as well as other computer machines or communication systems over one or more networks, such as network 2080. The network 2080 may include any type of data or communications network, including any of the network technology discussed with respect to FIG. 8.

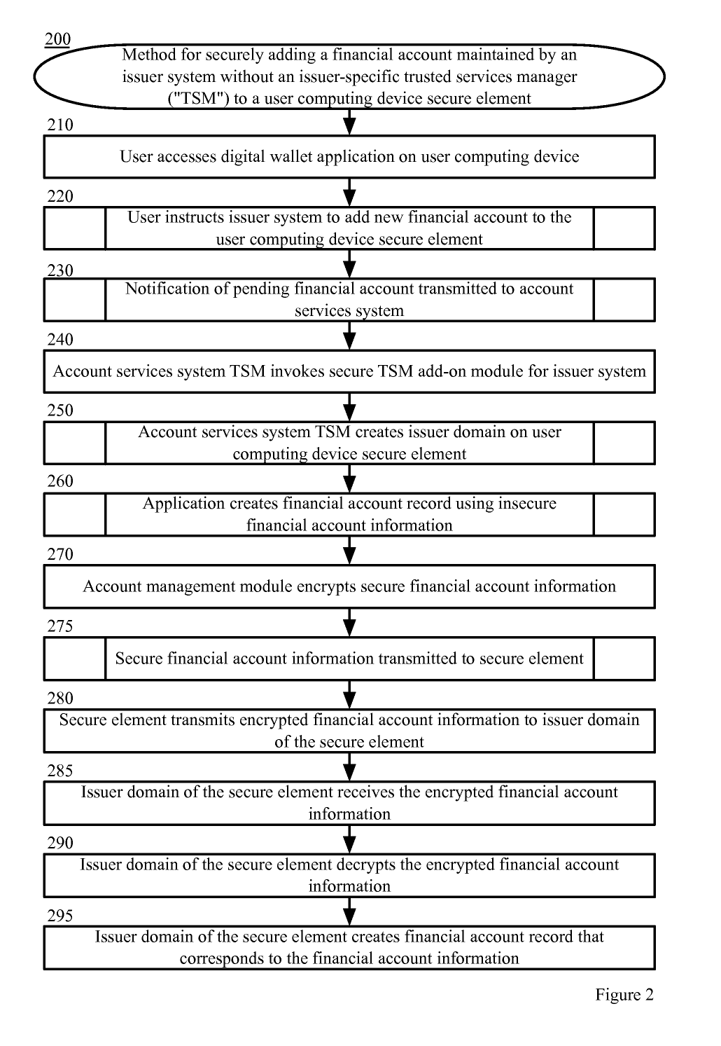

The components of the example operating environment 100 are described hereinafter with reference to the example methods illustrated in FIGS. 2-7. The example methods of FIGS. 2-7 may also be performed with other systems and in other environments.

### Example System Processes

FIG. 2 is a block flow diagram depicting a method for securely adding a financial account maintained by an issuer system 140 without an issuer-specific TSM to a user computing device 110 secure element 117, in accordance with certain example embodiments. The method 200 is described with reference to the components illustrated in FIG. 1.

In block 210, the user accesses an application 113 on the user computing device 110. In an example embodiment, the application 113 comprises a digital wallet, payment, merchant, issuer system 140, account services system 120, or other type of application 113 that securely stores financial account information.

In an example embodiment, the user has a digital wallet account and the user signs into the account via the user computing device 110 when the user accesses the application 113. In an example embodiment, the user utilizes the user interface 111 of the user computing device 110 to access the application. For example, the user may input a personal identification number or other identifying and/or authentication information to identify and access the application.

In an example embodiment, the user is prompted to log into, has previously logged into, or is otherwise automatically logged into the digital wallet application 113. In another example embodiment, the user's login credentials are shared across other accounts (for example, social networking websites and user computing device 110 accounts), and the user is automatically logged into digital wallet account using the shared login credentials. If the user does not have a digital wallet account, the user is typically prompted to create an account. In an example embodiment, the user may create the account at any time prior to adding a new financial card to the account. In an example embodiment, the user accesses the digital wallet account via a website or application 113. In an example embodiment, the user submits registration information, including, but not limited to, name, address, phone number, e-mail address, and/or other identifying information. In an example embodiment, the user's digital wallet account information is saved in the data storage unit 115 and is accessible to the account management module 129 and/or user services module 147.

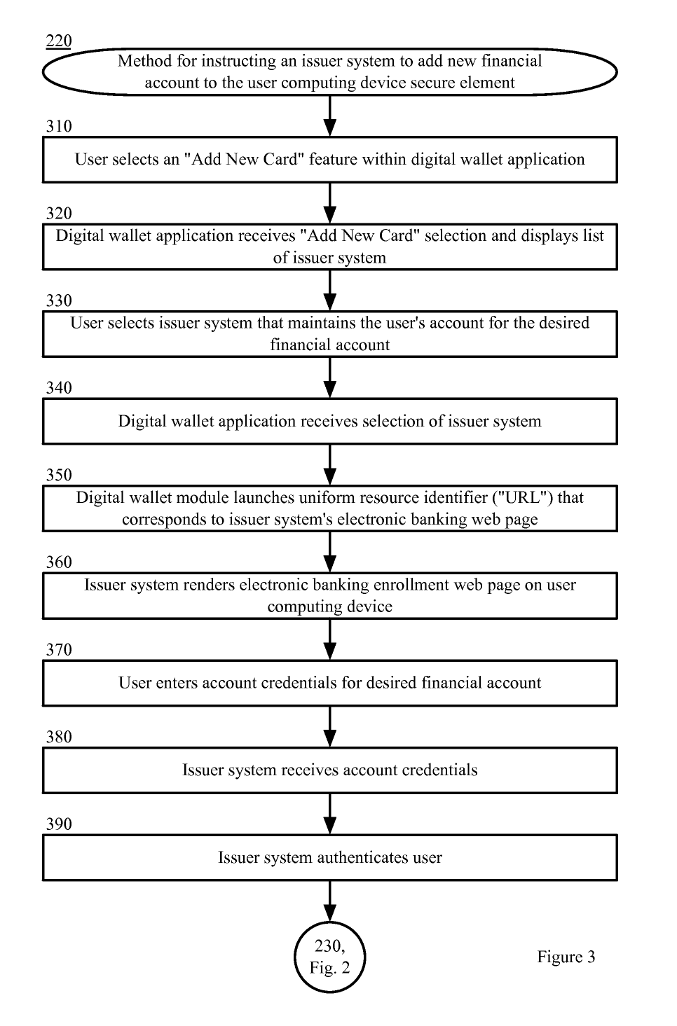

In block 220, the user instructs the issuer system 140 to add a new financial account to the secure element 117. In an example embodiment, the user instructs the issuer system 140 to add the new financial account to the digital wallet account or application 113. By instructing the issuer system 140 to add the new financial account to the digital wallet account, the issuer system 140 is in turn instructed to securely add the information to the secure element 117. The method for instructing an issuer system 140 to add a new financial account to the user computing device 110 secure element 117 is described in more detail hereinafter with reference to the methods described in FIG. 3.

FIG. 3 is a block flow diagram depicting a method 220 for instructing an issuer system 140 to add a new financial account to the user computing device 110 secure element 117, in accordance with certain example embodiments, as referenced in block 220. The method 220 is described with reference to the components illustrated in FIG. 1.

In block 310, the user selects an “Add New Card” feature from the digital wallet application 113. In an example embodiment, the feature is available for selection in a menu, button, link, or other selectable feature displayed on the user interface 111 of the user computing device 110.

In block 320, the digital wallet application 113 receives the “Add New Card” selection and displays a list of issuer systems 140. In an example embodiment, the digital wallet application 113 requests additional information from the user to complete the “Add New Card” instruction. In an example embodiment, the list of issuer systems 140 is displayed in searchable, scrollable, and/or alphabetized list. In another example embodiment, the list provides a number of “frequently chosen” issuer systems 140. In another example embodiment, the user is prompted to type in the full issuer system 140 name. In yet another example embodiment, the user is prompted to partially type the issuer system 140 and the digital wallet application 113 fills in the closest matching name. In another example embodiment, the user enters a financial account identifier, nickname, partial account number (for example the BIN range), or other input that is linked to the issuer system 140. In this embodiment, the issuer system 140 is identified by the digital wallet application, account services system 120, or other module using the entered identifier.

In block 330, the user selects the issuer system 140 that maintains the user's account for the desired financial account. For example, if the user's VISA account is maintained by Credit Union XYZ, the user selects, types, or enters the name Credit Union XYZ.

In block 340, the digital wallet application 113 receives the selection of the issuer system 140. In an example embodiment, the issuer system 140 was selected from a pre-defined list of issuer systems 140. In another example embodiment, the issuer system 140 name was entered by the user and the digital wallet application 113 correlates the entered name with a pre-defined list of issuer systems 140 to identify the correct issuer.

In block 350, the digital wallet application 113 launches a uniform resource identifier (“URL”) that corresponds to the identified issuer system's 140 electronic banking web page. In an example embodiment, a web browsing application 113 is opened on the user computing device 110 when the URL is launched. In another example embodiment, the URL is launched from within the digital wallet application 113. In an example embodiment, the digital wallet application 113 provides the issuer system 140 with an identifier that corresponds to the user computing device 110, digital wallet application 113, and/or secure element 117.

In block 360, the issuer system 140 renders the electronic banking enrollment web page on the user computing device 110. In an example embodiment, the electronic banking enrollment web page comprises form fields, buttons, menus, and blanks for information the issuer system 140 requires to add a new financial account to the secure element 117.

In block 370, the user enters the account credentials for the desired financial account. In an example embodiment, the users enters an account identifier, for example a financial account number, name, nickname, or other identifier that the issuer system 140 can use to identify the desire financial account. In another example embodiment, the issuer system 140 displays a list of the user's financial accounts and the user selects the desired financial account via the user interface 111.

In block 380, the issuer system 140 receives the user's selection of the desired financial account. In an example embodiment, the issuer system 140 is capable of correlating the user's selection or entered account information with an identity of the corresponding financial account maintained by the issuer system 140. In an example embodiment, the issuer system 140 reviews a list of the user's financial accounts and determines which financial account corresponds to the entered or selected information.

In block 390, the issuer system 140 authenticates the user. In an example embodiment, the user is prompted to enter a PIN, password, or other secret shared between the issuer system 140 and the user. In this embodiment, the issuer system 140 authenticates the user by determining whether the user enters the correct PIN, password, or other shared secret. In an example embodiment, the user is prompted to enter the PIN, password, or other shared secret when entering the financial account information.

In an example embodiment, the issuer system 140 creates a record, reference, or other indication of the user's desire to add the financial account information to the secure element 117. In an example embodiment, the issuer system 140 links the record to the user's financial account information to permit the issuer system 140 to locate the correct financial account information to write to the secure element 117.

The method 220 then proceeds to block 230 in FIG. 2.

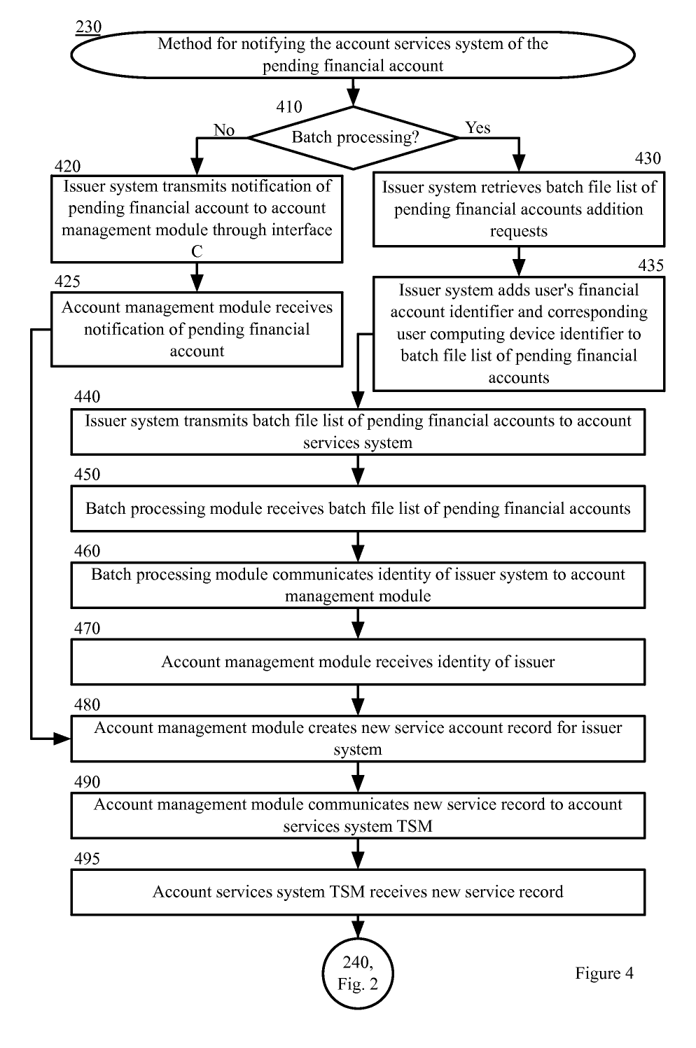

Returning to FIG. 2, in block 230, the issuer system 140 notifies the account services system 120 of the pending request to add the financial account information to the secure element 117. In an example embodiment, the issuer system 140 notifies the account services system 120 in real time or near real time with the user's instruction. In another example embodiment, the issuer system 140 prepares a batch list of financial accounts for one or more different users and transmits the batch list to the account services system 120. In an example embodiment, the issuer system 140 invokes a web service hosted by the account services system 120 to transmit the notification. In another example embodiment, the issuer system 140 transmits the notification in the form of a command or instruction over interface C to the account management module 129. In yet another example embodiment, the notification is transmitted via HTTP, FTP, or other file transfer protocol. The method for notifying the account services system 120 of the pending financial account is described in more detail hereinafter with reference to the methods described in FIG. 4.

FIG. 4 is a block flow diagram depicting a method 230 for notifying the account services system 120 of the pending financial account, in accordance with certain example embodiments, as referenced in block 230. The method 230 is described with reference to the components illustrated in FIG. 1.

In block 410, the issuer system 140 determines whether to notify the account services system 120 of the pending request to add the financial account information to the secure element 117 as part of a batch process or in real/near real time. In an example embodiment, the issuer system 140 has a pre-existing business relationship with the account services system 120 that determines how the notification will be transmitted.

If the notification is transmitted in real or near real time, the method 230 proceeds to block 420 in FIG. 4. In block 420, the issuer system 140 transmits notification of the pending financial account to the account management module 129 through interface C 137. In an example embodiment, interface C comprises a series of pre-defined API calls between the user services module 147 of the issuer system 140 and the account management module 129 of the account services system 120. The API specifies how the modules (including modules 147 and 129) should interact and exchange data, including the notification of the pending financial account. In another example embodiment, the notification is transmitted through a network 130 or other suitable means. In another example embodiment, the notification is transmitted at a pre-defined time interval.

In an example embodiment, the notification comprises an instruction or command sent by the issuer system 140 that a new financial account is to be added. In an example embodiment, the notification comprises an identification of the user computing device 110, the secure element 117, the digital wallet account and/or the user. In an example embodiment, the account management module 129 can identify the correct secure element 117 based on the identification provided. In an example embodiment, the notification further comprises the user's financial account identifier (for example, a financial account number, name, nickname, or other identifier that the issuer system 140 can use to identify the desire financial account). In another example embodiment, the user's financial account identifier comprises an identifier that cannot be used to complete a financial transaction. In this embodiment, the notification transmission is subject to less strict security requirements.

In block 425, the account management module 129 receives notification of the pending financial account. In an example embodiment, the account management module 129 receives the notification and responds to the user services module 147 by requesting additional information, confirming receipt of the transmission, or other exchange of data.

The method 230 then proceeds to block 480 in FIG. 4.

Returning to block 410 in FIG. 4, if the notification is transmitted as part of a batch process, the method 230 proceeds to block 430 in FIG. 4. In block 430, the issuer system 140 retrieves a batch file list of pending financial account addition requests. In an example embodiment, the batch list is transmitted at a pre-defined interval or once the number of requests reaches a pre-defined threshold.

In block 435, in an example embodiment, the account services module 147 adds the user's financial account identifier and corresponding user computing device 110 identifier to the batch file list of pending financial accounts. In an example embodiment, the user's financial account identifier comprises a financial account number, name, nickname, or other identifier that the issuer system 140 can use to identify the desire financial account. In another example embodiment, the user's financial account identifier comprises an identifier that cannot be used to complete a financial transaction. In this embodiment, the identifier and the batch file transmission are subject to less strict security requirements.

In block 440, the issuer system 140 transmits the batch file list of pending financial accounts to the account services system 120. In an example embodiment, the user services module 147 transmits the batch file to the batch processing module 127 through the network 130. In an example embodiment, the batch file is encrypted such that only the account services system 120 can open, read, and/or understand the contents of the file. In another example embodiment, the batch file is transmitted through a designated interface between the system (including systems 120 and 140).

In block 450, the batch processing module 127 receives the batch file. In an example embodiment, a series of pre-defined API calls between the user services module 147 of the issuer system 140 and the batch processing module 127 of the account services system 120 specifies how the modules (including modules 147 and 127) should interact and exchange data, including the batch file.

In block 460, the batch processing module 127 reads the batch file and communicates the identity of the issuer system 120 to the account management module 129. In an example embodiment, the batch processing module 127 decrypts some or all of the batch file to determine the identity of the issuer system 120. In another example embodiment, the batch processing module 127 transmits the decrypted or encrypted batch list to the account management module 129.

In block 470, the account management module 129 receives the notification of the identity of the issuer system 140 from the batch processing module 127. In an example embodiment, the account management module 129 determines the identity by reading the decrypted batch file or a part thereof.

In block 480, the account management module 129 creates a new service record for each requested new financial account. In an example embodiment, the new service record comprises and identity of the issuer system 140, the financial account identifier, and/or the user identifier. In an example embodiment, the new service record comprises information that permits the issuer system 140 to identify the correct user and financial account, and that permits the account services system TSM 121 to identity the correct user computing device 110 and secure element 117. In an example embodiment, the information contained in the service record is understandable by the account services system 120 and/or the issuer system 140, but cannot be used to complete a financial transaction. In this embodiment, the service record is subject to less strict security requirements.

In block 490, the account management module 129 communicates the new service record to the account services system TSM 121. In an example embodiment, the account services system TSM 121 can read and understand the information contained within the new services record to pull the corresponding financial account information from the issuer system 140 and pass it directly to the secure element 117. In another example embodiment, the account services TSM 121 can read and understand the information contained within the new services record to create an add-on module within the TSM 121 that corresponds to the issuer system 140.

In block 495, the account services system TSM 121 receives the new service record.

The method 230 then proceeds to block 240 in FIG. 2.

Returning to FIG. 2, in block 240, the account services system TSM 121 invokes a secure TSM add-on module for the issuer system 140. In an example embodiment, the core TSM 121 is partitioned to create the issuer TSM module 123. In an example embodiment, the core TSM 121 was partitioned prior to receiving the user's request to add the new financial account, for example when the business relationship between the account services system 120 and the issuer system 140 is established or shortly thereafter. In an example embodiment, the issuer TSM module 123 is a small, sub-module within the account services system TSM 121. In an example embodiment, the issuer TSM module 123 is a separate domain that cannot be accessed and/or controlled by the core TSM 121.

In an example embodiment, the issuer TSM module 123 allows smaller and less sophisticated issuer system 140 that lack the programming capabilities to acquire a separate TSM to write financial account information to a secure element 110. In an example embodiment, the issuer system 140 passes secure information through interface B 135 and insecure command information through interface C 137 to the account services system 120. In this embodiment, the issuer TSM module 123 allows the secure financial information to pass from the issuer system 140 account services system TSM 121 and then through the issuer TSM module 123 to the secure element 117 without being saved to the account services system 120. In an example embodiment, the account services system 120 defines which types of information are transmitted through each interface (including interface B 135 and interface C 137). In an example embodiment, the issuer TSM module 123 provides the issuer system 140 with TSM functionality that was previously not available to the issuer system 140, while partitioning the data transmitted to the account services system 120 such that secret data designated only for the issuer system 140 is not known or available to the core account services system TSM 121.

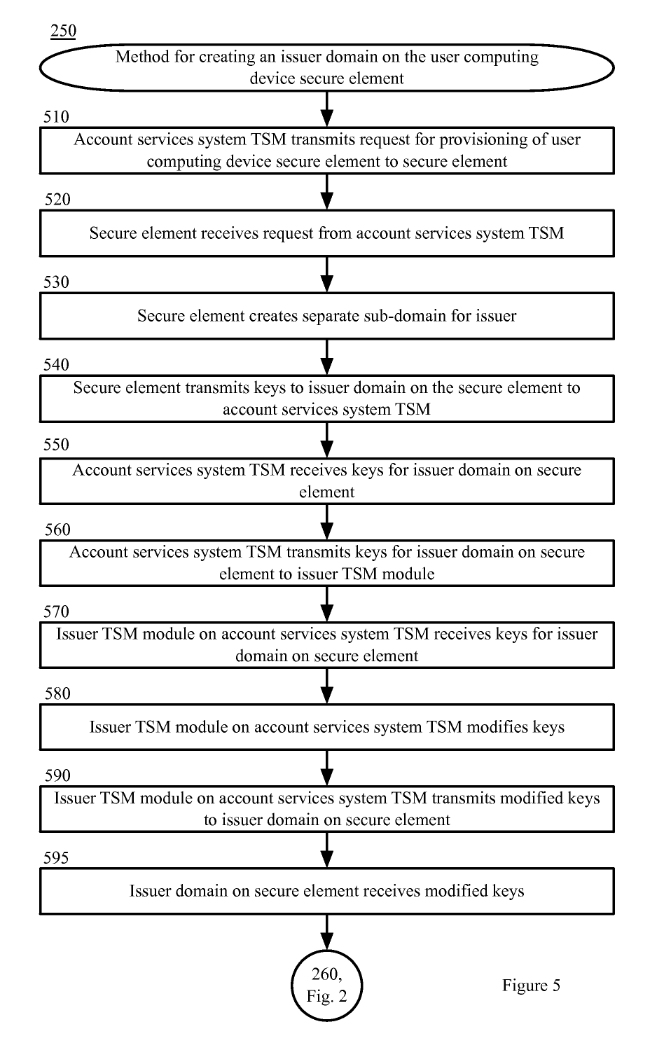

In block 250, the account services system TSM 121 creates an issuer domain 119 on the user computing device 110 secure element 117. In an example embodiment, the secure element 117 is controlled by the account services system 120. In this embodiment, the account services system TSM 121 comprises the keys necessary to write and modify information contained on the secure element 117. In an example embodiment, the account services system TSM 121 provisions a sub-domain within the secure element 117 for the issuer system 140. In this embodiment, financial information maintained by the issuer system 140 can be written to the issuer's specific subdomain 119 within the secure element 117. The method for creating an issuer domain 119 on the user computing device 110 secure element 117 is described in more detail hereinafter with reference to the methods described in FIG. 5.

FIG. 5 is a block flow diagram depicting a method 250 for creating an issuer domain 119 on the user computing device 110 secure element 117, in accordance with certain example embodiments, as referenced in block 250. The method 250 is described with reference to the components illustrated in FIG. 1.

In block 510, the account services system TSM 121 transmits a request for provisioning to the user computing device 110 secure element 117. In an example embodiment, the account services system TSM 121 comprises the keys required for communication with and provisioning of the secure element 117. In this embodiment, the issuer system 140 must engage the account services system TSM 121 to provision the secure element 117 and create a separate space within the secure element 117 to store financial account information maintained by the issuer system 140.

In block 520, the secure element 117 receives the request from the account services system TSM 121. In an example embodiment, the request is encrypted and transmitted via the network 130. In an example embodiment, the account services system TSM 121 and the secure element 117 communicate via a secure communication channel within the network 130.

In block 530, the secure element 117 decrypts the request for provisioning received from the account services system TSM 121 and creates a separate sub-domain for the issuer system 140. In an example embodiment, the separate sub-domain comprises the issuer domain 119. In this embodiment, the issuer domain 119 is a sub-domain comprised within the secure element 117 that remains autonomous and separate from the secure element 117. In an example embodiment, the issuer domain 119 comprises keys that are distinct and separate from the secure element 117 keys shared between the secure element 117 and the account services system TSM 121.

In block 540, the secure element 119 transmits the issuer domain 119 keys to the account services system TSM 121. In another example embodiment, the issuer domain 119 communicates the keys to the account services system TSM 121. In this embodiment, the account services system TSM 121 is capable of communicating encrypted information to secure element 117 that is directed to the issuer domain 119. Because the secure element 117 does not comprise the keys of the issuer domain 119, the secure element 117 is not capable of reading the encrypted information. In an example embodiment, the secure element 117 is capable of decrypting a portion of the information to determine which domain the information is to be directed to. In another example embodiment, the issuer TSM module 123 establishes the issuer domain 119 on the secure element 117 by creating an issuer system 140 specific secondary security domain (“SSD”) and loading an initial key set to this SSD in preparation for key rotation. In this embodiment, the keys are established by the account services system TSM 121 and then passed to the issuer TSM 123 once the issuer domain 119 is established on the secure element 117. The account services system TSM 121 passes the security keys created when the issuer domain 119 of the secure element 117 was created to the issuer TSM module 123 for key rotation.

In block 550, the account services system TSM 121 receives the keys for the issuer domain 119 on the secure element 117. In an example embodiment, the keys are transmitted via the network 130. In an example embedment, the keys are encrypted by the secure element 117 or issuer domain 119 such that only the account services system TSM 121 is capable of decryption.

In block 560, the account services system TSM 121 transmits the keys for the issuer domain 119 on the secure element 117 to the issuer TSM module 123. In an example embodiment, the issuer TSM module 123 is a add-on module that is distinct from the account services system TSM 121. In an example embodiment, the keys control the issuer domain 119 on the secure element 117 and allow for the addition or modification of financial account information in the issuer domain 119.

In block 570, the issuer TSM module 123 on the account services system TSM 121 receives the keys for the issuer domain 119 on the secure element 117.

In block 580, the issuer TSM module 123 on the account services system TSM 121 modifies the keys. In an example embodiment, the issuer TSM module 123 rotates, changes, or modifies the keys shared with the issuer domain 119. In an example embodiment, the issuer TSM module 123 rotates the keys and installs the rotated keys into the issuer domain 119 of the secure element. For example, the issuer TSM module 123 sends an “update key” command to the issuer system 140 specific SSD that was created in block 540 of FIG. 5. The issuer TSM module 123 encrypts the message with the initial key that was established by the account services system TSM 121 prior to key rotation. This way, the issuer system 140 specific SSD will use the known key to decrypt the message, and then see that it has a new key to put in place of the initial key. Once the initial key is replaced with the new key, the secure element 117 sends a confirmation back to the issuer TSM module 123 so that it knows that the new key was successfully programmed. The issuer TSM module 123 will then use the new key for future communications. In an example embodiment, the keys are changed to prevent the account services system TSM 121 and/or secure element 117 from being able to decrypt the financial account information exchanged between the issuer TSM module 123 and the issuer domain 119 on the secure element 117.

In block 590, the issuer TSM module 123 on the account services system TSM 121 transmits the modified keys to the issuer domain 119 on the secure element 117. In an example embodiment, the issuer TSM module 123 encrypts the modified keys and transmits the encrypted keys to the issuer domain 119 through the secure element 117. In an example embodiment, the secure element 117 receives the encrypted message and is capable of decrypting a portion of the message to determine that the message is to be routed to the issuer domain 119. In an alternative example embodiment, the issuer TSM module 123 encrypts the modified keys and transmits the encrypted keys to the account services system TSM 121, which transmits the keys to the to the issuer domain 119 through the secure element 117.

In block 595, the issuer domain 119 on the secure element 117 receives the modified keys. In another example embodiment, the issuer domain 119 updates the keys.

The method 250 then proceeds to block 260 in FIG. 2.

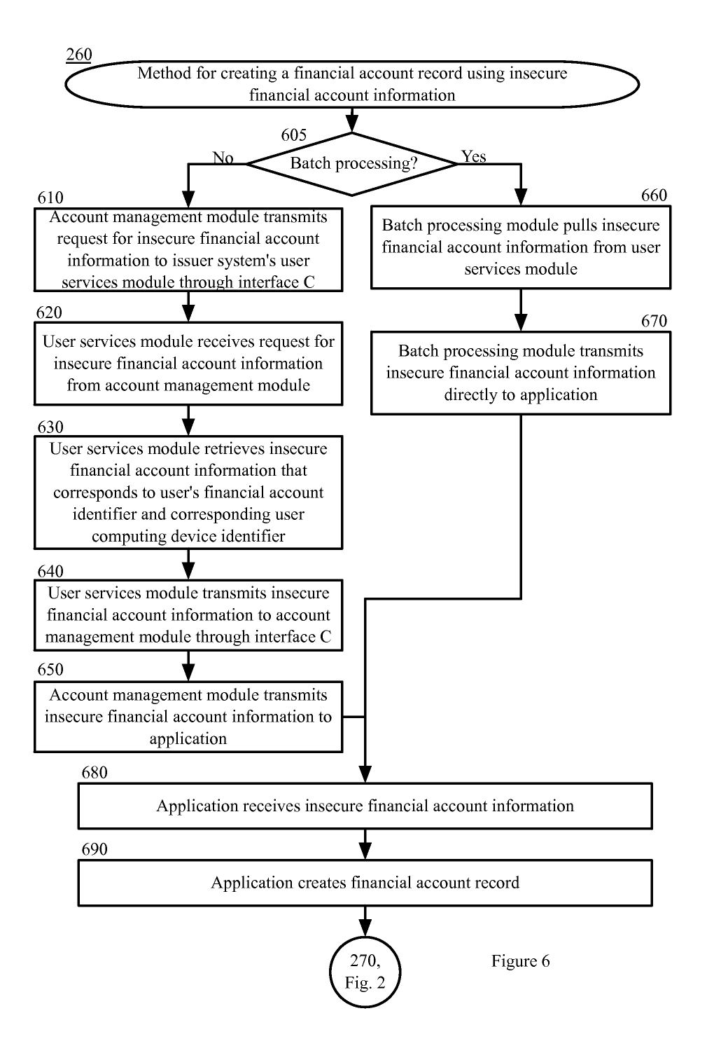

Returning to FIG. 2, in block 260, digital wallet application 113 creates a new financial account record using insecure financial account information received from the account management module 129. In an example embodiment, the insecure financial account information comprises instructions or commands to create a new record for the issuer system 140. In another example embodiment, the insecure financial account information comprises instructions or commands to create a new record for the financial account nickname or identifier maintained by the issuer system 140. The method for creating a financial account record using insecure financial account information is described in more detail hereinafter with reference to the methods described in FIG. 6.

FIG. 6 is a block flow diagram depicting a method 260 for creating a financial account record using insecure financial account information, in accordance with certain example embodiments, as referenced in block 260. The method 260 is described with reference to the components illustrated in FIG. 1.

In block 605, the issuer system 140 determines whether to notify the account services system 120 of the pending request to add the financial account information to the secure element 117 as part of a batch process or in real/near real time. In an example embodiment, the issuer system 140 has a pre-existing business relationship with the account services system 120 that determines how the notification will be transmitted. In an example embodiment, the issuer system 140 completed the determination prior to the creation of the issuer domain 119, in block 410 of FIG. 4.

If the notification is transmitted in real or near real time, the method 260 proceeds to block 610 in FIG. 6. In block 610, the account management module 129 transmits a request for insecure financial account information to the issuer system's 140 user services module 147 via interface C 137. In an example embodiment, interface C comprises a series of pre-defined API calls between the user services module 147 of the issuer system 140 and the account management module 129 of the account services system 120. The API specifies how the modules (including modules 147 and 129) should interact and exchange data, including the notification of the pending financial account. In another example embodiment, the notification is transmitted through a network 130 or other suitable means. In another example embodiment, the notification is transmitted at a pre-defined time interval. In an example embodiment, the notification is transmitted as a command or instruction in the series of pre-defined API calls. In an example embodiment, the notification comprises and identification of the user computing device 110 identifier and/or financial account identifier that were previously transmitted to the account management module 129 in block 420 of FIG. 4.

In block 620, the user services module 147 receives the request for insecure financial account information from the account management module 129.

In block 630, the user services module 147 retrieves insecure financial account information that corresponds to the user's financial account identifier and/or user computing device 110 identifier. In an example embodiment, the notification corresponds to the instruction or command sent by the issuer system 140 that a new financial account is to be added to the secure element 117. In an example embodiment, the notification comprises the user's financial account identifier (for example, a financial account number, name, nickname, or other identifier that the issuer system 140 can use to identify the desire financial account). In another example embodiment, the user's financial account identifier comprises an identifier that cannot be used to complete a financial transaction. In this embodiment, the notification transmission is subject to less strict security requirements.

In block 640, the user services module 147 transmits insecure financial account information to the account management module 129 via interface C 137. In an example embodiment, the insecure financial account information comprises instructions and commands to create and/or update financial account information on the issuer domain 119. In an example embodiment, the issuer system 140 separates sensitive financial information that can be used to complete a financial transaction and insecure account information such that the insecure information can be transmitted via interface C 137 with less strict security requirements.

In block 650, the account management module 129 receives the insecure financial account information from the user services module 147 and transmits it to the digital wallet application 113. In an example embodiment, the account management module 129 encrypts or modifies the insecure information so that it is understandable by the digital wallet application 113. In another example embodiment, the information is passed through the account management module 129 to the digital wallet application 113 with little processing or changes.

The method 260 then proceeds to block 680 in FIG. 6.

Returning to block 605 in FIG. 6, if the notification is transmitted as part of a batch process, the method 260 proceeds to block 660 in FIG. 6. In block 660, the batch processing module 127 pulls insecure financial account information from the user services module 147. In an example embodiment, the batch processing module 127 retrieves the user's financial account identifier (for example, a financial account number, name, nickname, or other identifier that the issuer system 140 can use to identify the desire financial account), user computing device 110 identifier, or other identifier from the batch list received from the issuer system 140 in block 450 of FIG. 4. In an example embodiment, the batch processing module 137 uses the identifier to pull the insecure financial account information from the user services module 147. In an example embodiment, the information pulled from the user services module 147 protected by encryption, such that only the digital wallet application 113 or other application and/or module with the proper decryption keys can open, read, and/or understand the contents of the file. In another example embodiment, the batch file is transmitted through a designated interface between the systems (including systems 120 and 140).

In block 670, the batch processing module 127 transmits the insecure financial account information directly to the digital wallet application 113. In an example embodiment, the account management module 129 encrypts or modifies the insecure information so that it is understandable by the digital wallet application 113. In another example embodiment, the information is passed through the account management module 129 to the digital wallet application 113 with little processing or changes

In block 680, the digital wallet application 113 receives the insecure financial account information. In an example embodiment, the information is decrypted so that it is understandable by the digital wallet application 113.

In block 690, the digital wallet application 113 creates a financial account record that corresponds to the insecure financial account information. In an example embodiment, the insecure financial account information comprises command and instructions to create a new record that corresponds to a financial account identifier. In an example embodiment, the financial account identifier corresponds to financial account information that will be added to the issuer domain 119 of the secure element 117.

The method 260 then proceeds to block 270 in FIG. 2.

Returning to FIG. 2, in block 270, the account management module 141 of the issuer system 140 encrypts the secure financial account information. In an example embodiment, the user services module 147 notifies the account management module 141 of the transmission or pull of the insecure financial account information to the digital wallet application 113. In response, the account management module 141 retrieves the corresponding secure financial account information and encrypts the information.

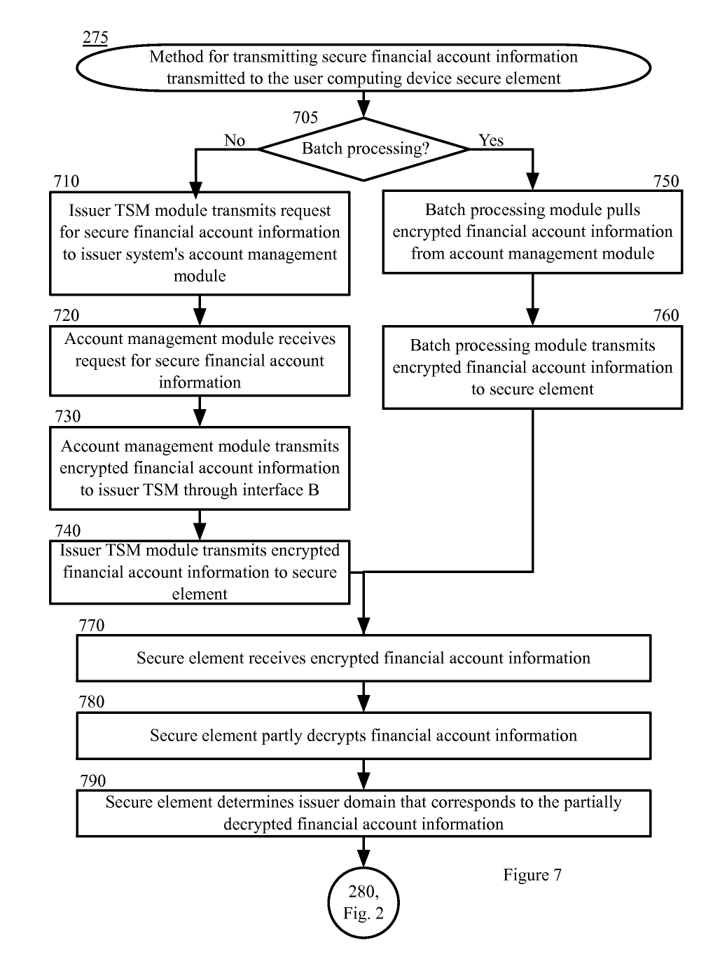

In block 275, the secure financial account information is transmitted to the secure element 117. In an example embodiment, the method of transmission is dependent upon the communication method between the issuer system 140 and the account services system 120. For example, whether the systems communicate in a batch process and information is pulled from the issuer system 140 or whether the systems (including systems 120 and 140) communicate via interfaces (including interface B 135 and interface C 137). The method for transmitting secure financial account information to the user computing device 110 secure element 117 is described in more detail hereinafter with reference to the methods described in FIG. 7.

FIG. 7 is a block flow diagram depicting a method 275 for transmitting secure financial account information to the user computing device 110 secure element 117, in accordance with certain example embodiments, as referenced in block 275. The method 275 is described with reference to the components illustrated in FIG. 1.

In block 705, the issuer system 140 determines whether to communicate with the account services system 120 as part of a batch process or in real/near real time. In an example embodiment, the issuer system 140 has a pre-existing business relationship with the account services system 120 that determines how the notification will be transmitted. In an example embodiment, the issuer system 140 completed the determination prior to the creation of the issuer domain 119, in block 410 of FIG. 4.

If the notification is transmitted in real or near real time, the method 275 proceeds to block 710 in FIG. 7. In block 710, the issuer TSM module 123 transmits a request for the secure financial account information to the issuer system's 140 account management module 141 via interface B 135. In this example embodiment, the user's account information is transmitted between the issuer system 140 and the issuer TSM module 123 of the account services system TSM 121 via interface B. In an example embodiment, interface B comprises a series of pre-defined API calls between the account management module 141 of the issuer system 140 and the account services system TSM 121. The API specifies how the modules (including modules 141 and 121) should interact and exchange data, including the notification of the pending financial account. In another example embodiment, the notification is transmitted through a network 130 or other suitable means. In another example embodiment, the notification is transmitted at a pre-defined time interval. In an example embodiment, the notification is transmitted as a command or instruction in the series of pre-defined API calls. In an example embodiment, the notification comprises and identification of the user computing device 110 identifier and/or financial account identifier that were previously transmitted to the account management module 129 in block 420 of FIG. 4. In another example embodiment, the account services system TSM 121 communicates the request to the issuer TSM module 123, which in turn communicates the request to the account management module 141 through interface B 135.

In block 720, the account management module 141 receives the request for secure financial account information. In an example embodiment, the request in decrypted by the account management module 141 and read.

In block 730, the account management module 141 transmits encrypted financial account information to the issuer TSM module 123 of the account services system TSM 121. In an example embodiment, the issuer TSM module 123 of the account management module 141 transmits an embossing file or an EMV Card Personalization Specification (“CPS”) file over interface B 135 to the issuer TSM module 123 of the account services system TSM 121.

In block 740, the issuer TSM module 123 of the account services system TSM 121 transmits the encrypted financial account information to the secure element 117. In an example embodiment, the issuer TSM module 123 of the account services system TSM 121 performs any required data preparation in advance of sending the encrypted data stream to the secure element 117. In an example embodiment, the financial account information is translated into a format expected by the secure element 117. In another example embodiment, the financial account information is encrypted using the issuer domain 119 keys previously set-up on the secure element 117. In an example embodiment, the encrypted financial account information is not stored or saved by the account services system TSM 121. Instead the data is prepared for direct transmission to the secure element 117. In an example embodiment, the account services system TSM 121 comprises the keys required to communicate with the secure element 117, but not with the issuer domain 119. In this example embodiment, the encrypted financial account information is prepared by the account services system TSM 121 by enabling secure transmission to the secure element 117 and partial decryption by the secure element 117 to determine the correct issuer domain 119 to transmit the encrypted information.

The method 275 then proceeds to block 770 in FIG. 7.

Returning to block 750 in FIG. 7, if the notification is transmitted as part of a batch process, the method 275 proceeds to block 750 in FIG. 7. In block 750, the batch processing module 127 pulls encrypted financial account information from the account management module 141. In an example embodiment, the batch processing module 127 retrieves the user's financial account identifier (for example, a financial account number, name, nickname, or other identifier that the issuer system 140 can use to identify the desire financial account), user computing device 110 identifier, or other identifier from the batch list received from the issuer system 140 in block 450 of FIG. 4. In an example embodiment, the batch processing module 137 uses the identifier to pull the encrypted financial account information from the account management module 141. In an example embodiment, the information pulled from the account management module 141 is encrypted such that only the issuer domain 119 can open, read, and/or understand the contents of the file. In another example embodiment, the batch file is transmitted through a designated interface between the systems (including systems 120 and 140).

In block 760, the batch processing module 127 transmits the encrypted financial account information to the secure element 117. In an example embodiment, the batch processing module 127 is a part of the issuer TSM module 123. In an example embodiment, the batch processing module 127 transmits the encrypted financial account information through the issuer TSM module 123 of the account services system TSM 121. In this example embodiment, the issuer TSM module 123 of the account services system TSM 121 encrypts or modifies the encrypted information so that the secure element 117 is capable of determining that the information is to be routed to the issuer domain 119. In another example embodiment, the information is passed through the issuer TSM module 123 of the account services system TSM 121 to the secure element with little processing or changes.

In block 770, the secure element 117 receives the encrypted financial account information from the account services system 140.

In block 780, the secure element 117 partially decrypts the financial account information. In an example embodiment, the secure element 117 is only capable of partial decryption since it lacks the keys stored in the issuer domain 119. In this embodiment, the secure element 117 partially decrypts the financial account information so that it is capable of identifying the issuer system 140 and then is able to target the corresponding issuer domain 119.

In block 790, the secure element 117 reads the partially decrypted financial account information and identifies the issuer domain 119.

The method 275 then proceeds to block 280 in FIG. 2.

Returning to FIG. 2, in block 280, the secure element 117 transmits the encrypted financial account information to the issuer domain 119 on the secure element 117. In an example embodiment, the secure element 117 identifies the issuer domain 119 from the partially decrypted financial account information and transmits the encrypted information to the identified issuer domain 119.

In block 285, the issuer domain 119 of the secure element 117 receives the encrypted financial account information.

In block 290, the issuer domain 119 decrypts the encrypted financial account information. In an example embodiment, the issuer domain 119 comprises the keys shared with the issuer TSM module 123 and is capable of decrypting, reading, and understanding the financial account information. In an example embodiment, the decrypted financial account information comprises the financial account number, expiration date, security code, user name, billing address, and other sensitive information required to complete a financial purchase. In another example embodiment, the decrypted financial account information also comprises the financial account identifier transmitted to the digital wallet application 113. In another example embodiment, the financial account information comprises proxy account information. In this example embodiment, the proxy account number comprises a token or other proxy identifier known to the issuer system 140, but not the actual financial account number

In block 295, the issuer domain 119 creates a financial account record that corresponds to the decrypted financial account information. In an example embodiment, the financial account record stored in the issuer domain 119 further corresponds to the financial account record stored in the digital wallet application 113. In this embodiment, the financial account identifier used by the digital wallet application 113 is linked to or associated with the financial account information saved by the issuer domain 119 in the financial account record. In an example embodiment, the user can select the financial account identifier from the digital wallet application 113 and a link will be established that allows the user to pay with the associated financial account information stored in the issuer domain 119.

### Other Example Embodiments

FIG. 8 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read- only memory (ROM), programmable read-only memory (PROM), erasable programmable read-only memory (EPROM), flash memory, or any other device capable of storing program instructions or data with or without applied power. The system memory 2030 may also include volatile memories such as random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (SOC), system on package (SOP), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to enable an issuer system without an issuer-specific trusted services manager to allow users to securely store financial account information for use in a digital wallet application, comprising:
receiving, by one or more computing devices operated by an account services system and from an issuer system through a first interface designated for transmission of insecure information, a request to add a financial account maintained by the issuer system to a digital wallet application, the issuer system without an issuer-specific trusted services manager (“TSM”) required to securely add the financial account to the digital wallet application;
invoking, by a TSM of the account services system, a partitioned add-on TSM module within the account services system TSM that is designated for the issuer system;
receiving, by the one or more computing devices operated by the account services system and from the issuer system through the first interface designated for transmission of insecure information, insecure financial account information, the insecure financial account information comprising an account identifier for the financial account;
transmitting, by the one or more computing devices operated by the account services system, the insecure financial account information to the digital wallet application for creation of a financial account record within the digital wallet application for the financial account, the financial account record comprising the account identifier;
receiving, by the partitioned add-on TSM module within the account services system TSM that is designated for the issuer system and from the issuer system through a second interface designated for transmission of secure information, secure financial account information;
preparing, by the partitioned add-on TSM module within the account services system TSM that is designated for the issuer system, the secure financial account information for transmission to a secure element associated with the digital wallet application; and
transmitting, by the partitioned add-on TSM module within the account services system TSM that is designated for the issuer system, the prepared secure financial account information to the secure element.

2. The computer-implemented method of claim 1, wherein the first interface comprises a first series of a series of application program interface calls between the account services system and the issuer system that define protocols for transmitting insecure information.

3. The computer-implemented method of claim 1, wherein the second interface comprises a second series of a series of application program interface calls between the account services system and the issuer system that define protocols for transmitting secure information.

4. The computer-implemented method of claim 1, wherein preparing the secure financial account information for transmission to the secure element comprises:
translating, by the partitioned add-on TSM module within the account services system TSM that is designated for the issuer system, the secure financial account information into a formatted understandable by the secure element; and
encrypting, by the partitioned add-on TSM module within the account services system TSM that is designated for the issuer system, the secure financial account information using keys for an issuer domain within the secure element.

5. The computer-implemented method of claim 1, wherein invoking the partitioned add-on TSM module within the account services system TSM that is designated for the issuer system comprises:
creating, by the one or more computing devices, an account record for the request to add the financial account maintained the issuer system; and
communicating, by the one or more computing devices, the account record for the request to add the financial account maintained the issuer system to the account services system TSM.

6. The computer-implemented method of claim 1, wherein the secure financial account information is prepared and transmitted to the secure element without saving or storing the secure financial information by the one or more computing devices operated by the account services system.

7. The computer-implemented method of claim 1, further comprising creating the issuer domain on the secure element, wherein the prepared secure financial account information is transmitted to the issuer domain on the secure element.

8. The computer-implemented method of claim 6, further comprising:
receiving, by the secure element, the prepared secure financial account information;
partially decrypting, by the secure element, the prepared secure financial account information to determine an identity of the issuer domain; and
transmitting, by the secure element, the partially decrypted financial account information to the issuer domain.

9. A computer program product, comprising:
a non-transitory computer-readable medium having computer-readable program instructions embodied therein that when executed by a computer cause the computer to enable an issuer system without an issuer-specific trusted services manager to allow users to securely store financial account information for use in a digital wallet application, the computer-readable program instructions comprising:
computer-readable program instructions to receive, by one or more computing devices operated by an account services system and from an issuer system through a first interface designated for transmission of insecure information, a request to add a financial account maintained by the issuer system to a digital wallet application, the issuer system without an issuer-specific trusted services manager (“TSM”) required to securely add the financial account to the digital wallet application;
computer-readable program instructions to receive, by the one or more computing devices operated by the account services system and from the issuer system through the first interface designated for transmission of insecure information, insecure financial account information, the insecure financial account information comprising an account identifier for the financial account;
computer-readable program instructions to transmit, by the one or more computing devices operated by the account services system; the insecure financial account information to the digital wallet application for creation of a financial account record within the digital wallet application for the financial account, the financial account record comprising the account identifier;
computer-readable program instructions to receive, by a partitioned add-on TSM module within an account services system TSM that is designated for the issuer system and from the issuer system through a second interface designated for transmission of secure information, secure financial account information;
computer-readable program instructions to prepare, by the partitioned add-on TSM module within the account services system TSM that is designated for the issuer system, the secure financial account information for transmission to a secure element; and
computer-readable program instructions to transmit, by the partitioned add-on TSM module within the account services system TSM that is designated for the issuer system, the prepared secure financial account information to the secure element.

10. The computer program product of claim 9, further comprising computer-readable program instructions to invoke, by a TSM of the account services system, the partitioned add-on TSM module within the account services system TSM that is designated for the issuer system.

11. The computer program product of claim 9, wherein the first interface comprises a first series of a series of application program interface calls between the account services system and the issuer system that define protocols for transmitting insecure information.

12. The computer program product of claim 9, wherein the second interface comprises a second series of a series of application program interface calls between the account services system and the issuer system that define protocols for transmitting secure information.

13. The computer program product of claim 9, wherein preparing the secure financial account information for transmission to the secure element comprises:
computer-readable program instructions to translate, by the partitioned add-on TSM module within the account services system TSM that is designated for the issuer system, the secure financial account information into a formatted understandable by the secure element; and
computer-readable program instructions to encrypt, by the partitioned add-on TSM module within the account services system TSM that is designated for the issuer system, the secure financial account information using keys for an issuer domain within the secure element.

14. The computer program product of claim 9, wherein the secure financial account information is prepared and transmitted to the secure element without saving or storing the secure financial information by the one or more computing devices operated by the account services system.

15. A system to enable an issuer system without an issuer-specific trusted services manager to allow users to securely store financial account information for use in a digital wallet application, comprising:
a storage device; and
a processor communicatively coupled to the storage device, wherein the processor executes application code instructions that are stored in the storage device to cause the system to:
receive, by one or more computing devices operated by an account services system and from an issuer system through a first interface designated for transmission of insecure information, a request to add a financial account maintained by the issuer system to a digital wallet application, the issuer system without an issuer-specific trusted services manager (“TSM”) required to securely add the financial account to the digital wallet application;
receive, by the one or more computing devices operated by the account services system and from the issuer system through the first interface designated for transmission of insecure information, insecure financial account information, the insecure financial account information comprising an account identifier for the financial account;
transmit, by the one or more computing devices operated by the account services system; the insecure financial account information to the digital wallet application for creation of a financial account record within the digital wallet application for the financial account, the financial account record comprising the account identifier;
receive, by a partitioned add-on TSM module within an account services system TSM that is designated for the issuer system and from the issuer system through a second interface designated for transmission of secure information, secure financial account information; and
transmit, by the partitioned add-on TSM module within the account services system TSM that is designated for the issuer system, the prepared secure financial account information to the secure element.

16. The system of claim 15, wherein the processor is further configured to execute computer-executable instructions stored in the storage device to cause the system to invoke, by a TSM of the account services system, the partitioned add-on TSM module within the account services system TSM that is designated for the issuer system.

17. The system of claim 15, wherein the first interface comprises a first series of a series of application program interface calls between the account services system and the issuer system that define protocols for transmitting insecure information.

18. The system of claim 15, wherein the second interface comprises a second series of a series of application program interface calls between the account services system and the issuer system that define protocols for transmitting secure information.

19. The system of claim 15, wherein the secure financial account information is transmitted to the secure element without saving or storing the secure financial information by the one or more computing devices operated by the account services system.

20. The system of claim 15, wherein the processor is further configured to execute computer-executable instructions stored in the storage device to cause the system to prepare, by the partitioned add-on TSM module within the account services system TSM that is designated for the issuer system, the secure financial account information for transmission to a secure element.
